(19) United States
(12) Patent Application Publication
(10) Pub. No.: US 2021/0240020 A1
(43) Pub. Date: Aug. 5, 2021

(54) DISPLAY DEVICES WITH ROTATABLE LIGHT EMITTING DIODES

(71) Applicant: Hewlett-Packard Development Company, L.P., Spring, TX (US)

(72) Inventors: Chi-Hao Chang, Taipei City (TW); Hsing-Hung Hsieh, Taipei City (TW); Kuan-Ting Wu, Taipei City (TW)

(73) Assignee: Hewlett-Packard Development Company, L.P., Spring, TX (US)

(21) Appl. No.: 17/048,629

(22) PCT Filed: Sep. 7, 2018
(86) PCT No.: PCT/US2018/049817

§ 371 Date: Oct. 19, 2020

(51) Int. Cl. G02F 1/13; G02F 1/13357; G09G 3/34

(52) U.S. Cl. CPC G02F 1/1323; G02F 1/133603; G02F 1/133608; G09G 2300/08; G09G 2320/068; G09G 2358/00; G09G 3/342

(57) ABSTRACT

In one example, a display device may include a liquid crystal panel and a direct type backlight unit having a light emitting diode (LED) package disposed behind the liquid crystal panel. The LED package may include a plurality of LEDs. The plurality of LEDs may have a first orientation towards the liquid crystal panel to provide a first viewing angle. Further, the display device may include a control unit to rotate the LED package to allow the plurality of LEDs to have a second orientation towards the liquid crystal panel to provide a second viewing angle. The second viewing angle may be narrower than the first viewing angle.

### BACKGROUND

The emergence and popularity of mobile computing has made electronic devices, due to their compact design and light weight, a staple in today's marketplace. Electronic devices, such as mobile phones, notebooks and tablets, may include a display that outputs information to users. Example display may include a micro-light emitting diode (micro-LED or μLED) display. Micro-LED displays may have arrays of microscopic LEDs forming the individual pixel elements. The users may use the display to view private information, such as private financial information or a confidential email. Because of the increased portability of electronic devices, users can transport and use the electronic devices in public areas where the privacy is minimal.

### BRIEF DESCRIPTION OF THE DRAWINGS

Examples are described in the following detailed description and in reference to the drawings, in which:

FIG. 1A is a cross-sectional view of an example display device, depicting a light emitting diode (LED) package including a plurality of LEDs having a first orientation towards a liquid crystal panel;

FIG. 1B is a cross-sectional view of the example display device of FIG. 1A, depicting the plurality of LEDs having a second orientation towards the liquid crystal panel;

FIG. 1C is schematic diagram rating the example LED package of FIG. 1A;

FIG. 1D is a schematic diagram illustrating a top view of an example direct type backlight unit of FIG. 1A, depicting the example LED package in a narrow viewing angle;

FIG. 2A is a cross-sectional view of an example display device, depicting a control unit to rotate an LED to control a viewing angle;

FIG. 2B is a cross-sectional view of he example display device of FIG. 2A, depicting additional features; and

FIG. 3 depicts a block diagram of an example computing device including a machine-readable storage medium, storing instructions to implement a privacy mode of a display.

### DETAILED DESCRIPTION

Electronic devices, such as mobile phones, notebooks and tablets, may include a display that outputs information to users. The users may use the display to view private information, such as private financial information or a confidential email. Often, the user may be in public, such as when the user is sitting in a waiting room, standing in line, or riding on public transportation. In such situations, other people may view the display of the users electronic device, particularly when the users electronic device includes a display viewable from a wide variety of angles. In some examples, the viewing angle may be controlled by reducing brightness of a display and increasing power for light emitting diode (LED) backlighting. However, this may increase power consumption and impact brightness of the display. In some other examples, detachable privacy screens may be used at displays to restrict propagation direction of light emitted from the displays. In such cases, the use of privacy screens may inhibit or reduce functionality of a touch screen associated with the displays.

Examples described herein may control different degree of privacy modes on, a display device by rotating an LED to narrow down a viewing angle. Example display device may include a micro-LED (μ-LED) display, a mini-LED display, a micro-electro-mechanical systems (MEMS) display, or the like. For example, micro-LED display, also known as m-LED or μ-LED, is an emerging flat panel display technology having arrays of microscopic LEDs that form the individual pixel elements. Example display device may include a plurality of LED packages. Each LED package may include at least one micro-LED or mini-LED. In other examples, each LED package may include an LED of a MEMS-type.

In one example, the display device may include a liquid crystal panel and a direct type backlight unit having an LED package disposed behind the liquid crystal panel. The LED package may include a plurality of LEDs, the plurality of LEDs is to have a first orientation towards the liquid crystal panel to provide a wide viewing angle. Further, the display device may include a control unit to rotate the LED package to allow the plurality of LEDs to have a second orientation towards the liquid crystal panel to provide a narrow viewing angle.

Examples described herein may provide a switchable privacy control on the display device to control the viewing angle and protect a display from prying eyes. In this case, the LED packages can be rotated to change the light direction when the user selects the privacy mode. Thus, sensitive data, such as information associated with insurance, banking, finance, human resources, trade, examination rooms, medical personnel, security applications, or the like, can be protected from the prying eyes.

Examples described herein may provide a 2-way or a 4-way privacy control (i.e., a horizontal viewing angle control and/or a vertical viewing angle control) based on an arrangement of the LED packages on the direct type backlight unit. Examples described herein may also provide a multi-mode privacy control. For example, a degree of privacy on the display can be controlled by rotating the LED packages to multiple orientations corresponding to multiple privacy modes. Examples described herein may also provide a high brightness privacy control solution for the displays. Thus, examples described herein may provide the multi-mode privacy control with efficient power consumption and without impacting the brightness of the display.

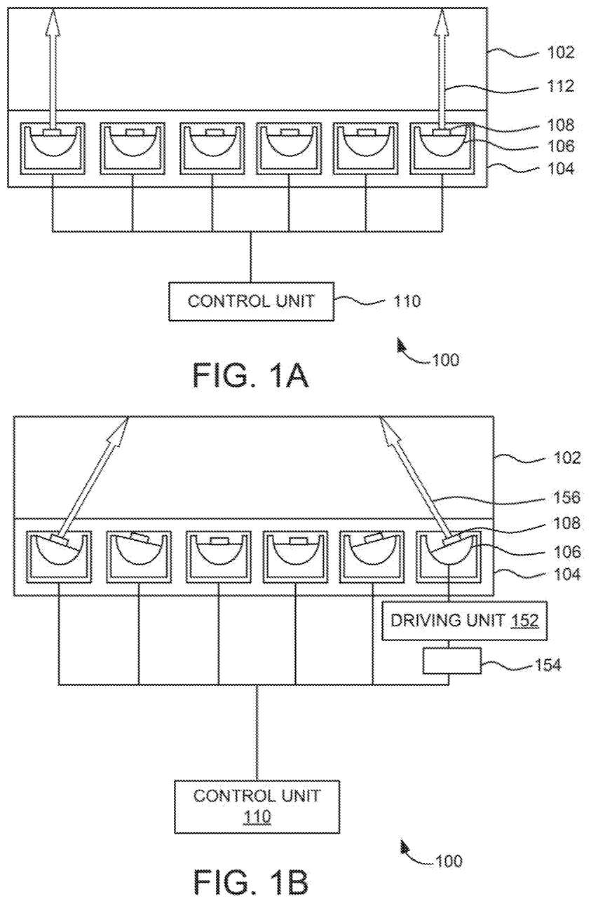

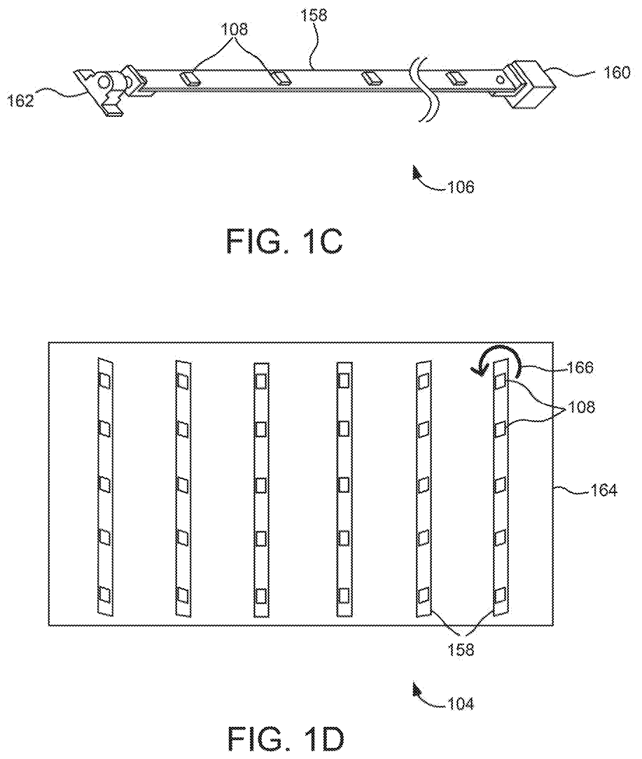

Referring to the figures, FIG. 1A is a cross-sectional view of an example display device 100, depicting an LED package 106 including a plurality of LEDs 108 having, a first orientation towards a liquid crystal panel 102. Display device 100 may include an external display to a computing device, an internal display to the computing device, or any combination thereof. Example display device 100 may include a touchscreen display.

Example display device 100 may include liquid crystal panel 102. Further, display device 100 may include a direct type backlight unit 104 including LED package 106 disposed behind liquid crystal panel 102. In some examples, display device 100 may include a plurality of LED packages, for instance, integrated to a circuit board of display device 100. Each LED package may include a plurality of LEDs. In one example, the LED packages may be arranged in columns and/or rows. In another example, the LED packages may be uniformly arranged.

Direct type backlight unit 104 may indicate that LEDs 108 are arranged at back of liquid crystal panel 102 as backlight. In direct type backlight unit 104, the plurality of LED packages may be arranged at the back of liquid crystal panel 102, for instance in vertical columns, where each LED package 106 may include multiple LEDs 108 connected in series.

In one example, plurality of LEDs 108 may have a first orientation towards liquid crystal panel 102 to provide a first viewing angle (e.g., as shown by arrow 112 of FIG. 1A). For example, liquid crystal panel 102 may be disposed above LED package 106 such that the light emitted by LEDs 108 may exit direct type backlight unit 104 and transmit through liquid crystal panel 102 to reach the user's eyes. In this example, plurality of LEDs 108 may have the first orientation towards and parallel to liquid crystal panel 102.

For example, display device 100 may output data via an array of pixel elements. Each LED package 106 may include at least one μ-LED pixel that can be driven to emit light. A pixel may refer to a component of display device 100 that can be used to build the image. For example, each μ-LED pixel may include a red pixel, a green pixel, a blue pixel, or any combination thereof, which can be independently controlled to produce a range of colors.

Furthermore, display device 100 may include a control unit 110 coupled to LED package 106. In some examples, control unit 110 may be implemented as engines or modules comprising any combination of hardware and programming to implement the functionalities described herein.

During operation, control unit 110 may rotate LED package 106 to allow plurality of LEDs 108 to have a second orientation towards liquid crystal panel 102 to provide a second viewing angle (e.g., as shown by arrow 156 of FIG. 1B). In this example, the second viewing angle may be narrower than the first viewing angle. FIG. 1B is a cross-sectional view of example display device 100 of FIG. 1A, depicting plurality of LEDs 108 having the second orientation towards liquid crystal panel 102. For example, similarly named elements of FIG. 1B may be similar in structure and/or function to elements described with respect to FIG. 1A.

As shown in FIG. 1B, control unit 110 may rotate LED package 106 at an angle in a range of 0 to 75 degrees to change the light direction of LEDs 108 to provide the second viewing angle. In one example, display device 100 may include a driving unit 152 coupled to LED package 106 to rotate LED package 106. Further, display device 100 may include an electromagnetic switch 154 to activate or drive driving unit 152. An example mechanism to rotate LED package 106 is shown in FIGS. 1C and 1D. FIGS. 1A and 18 describe driving unit 152 as being coupled to LED package 106, however, driving unit 152 can be coupled to an LED or a plurality of LED packages such that driving unit 152 can rotate the LED, an LED package having a plurality of LEDs, or the plurality of LED packages to provide the second viewing angle.

FIG. 1C is a schematic diagram illustrating example LED package 106 of FIG. 1A. In one example, LED package 106 may include an LED bar 158. In this example, plurality of LEDs 108 may be disposed on LED bar 158. Further, LED package 106 may include driving unit 152 to drive LED bar 158 to rotate.

In one example, driving unit 152 may include an electric motor 160. One end of LED bar 158 may be pivoted to a fixed support 162 and other end of LED bar 158 may be connected to an output shaft of electric motor 160. For example, fixed support 162 may be connected to a backplane (e.g., backplane 164 as shown in FIG. 10). Electromagnetic switch 154 may energize and de-energize electric motor 160 to rotate LED bar 158. Control unit 110 may selectively energize and de-energize electric motor 160 by turning on and off electromagnetic switch 154. In other examples, electric motor 160 may be a reciprocating motor, and the rotating range of the output shaft may be about 0-75 degrees. Using such a solution, the control logic of electric motor 160 may be relatively simple and the rotation position of LED bar 158 may be precisely controlled.

FIG. 1D is a schematic diagram illustrating a top view of example direct type backlight unit 104 of FIG. 1A, depicting example LED package 106 (e.g., LED bar 158) in a narrow viewing angle. As shown in FIG. 1D, direct type backlight unit 104 may include a backplane 164. Direct type backlight unit 104 may also include a plurality of LED bars 158 each including plurality of LEDs 108. Backplane 164 may have a holding space, and plurality of LED bars 158 (e.g., LED packages 106) may be disposed inside the holding space of backplane 164. Liquid crystal panel 102 may be disposed above plurality of LED bars 158. Each LED bar 158 can be rotatable to allow plurality of LEDs 108 to have the first orientation and the second orientation toward liquid crystal panel 102. In the example shown in FIG. 1D, LED bar 158 may be rotated (e.g., in a direction, as shown by arrow 166) to the second orientation toward liquid crystal panel 102 to provide the narrow viewing angle in a privacy mode.

The privacy mode may be activated explicitly by a user or may be activated in response to a privacy mode trigger event. In one example, touchscreen may be used to detect a gesture to activate and/or de-activate the privacy mode. In another example, the privacy mode may be activated and/or deactivated via a keyboard and/or keypad. In yet another example, microphone in display device 100 may be used to detect a spoken command to activate the privacy mode. In yet another example, the privacy mode or the normal mode may be manually selected by a user. In yet another example, the privacy mode or the normal mode may be automatically detected based on user gestures through at least one sensor disposed in display device 100. Example sensor may include a camera.

Thus, LED package 106 may be rotatable to the first and second orientations to switch the viewing angle between a wide viewing angle and a narrow viewing angle. The wide viewing angle may refer to a maximum angle at which information/content displayed on display device 100 can be viewed. The wide viewing angle may be greater than the narrow viewing angle. During privacy mode of operation, the viewing angle (e.g., range of viewing the sensitive information on display device 100) may need to be restricted to prevent other users from viewing the display of display device 100. In this case, the viewing angle of the display may be switched to the narrow viewing angle to enable privacy of the information/content displayed on the display. During normal mode of operation, the viewing angle of the display may be switched to the wide viewing angle.

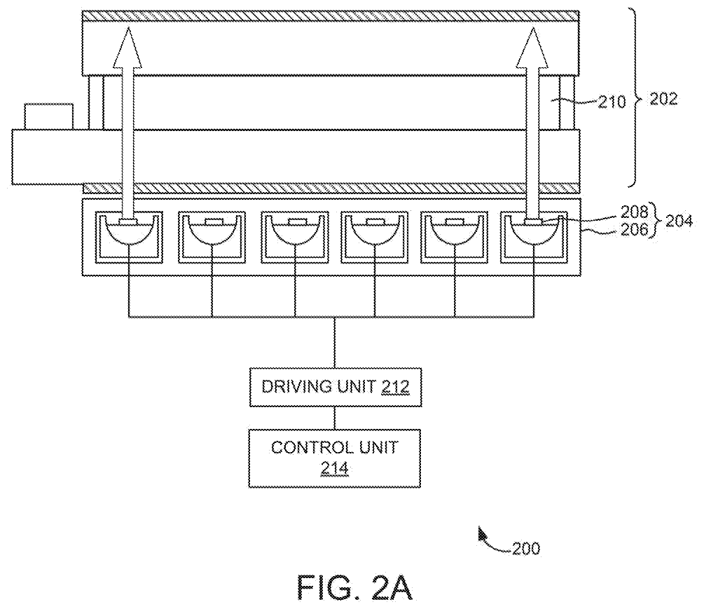

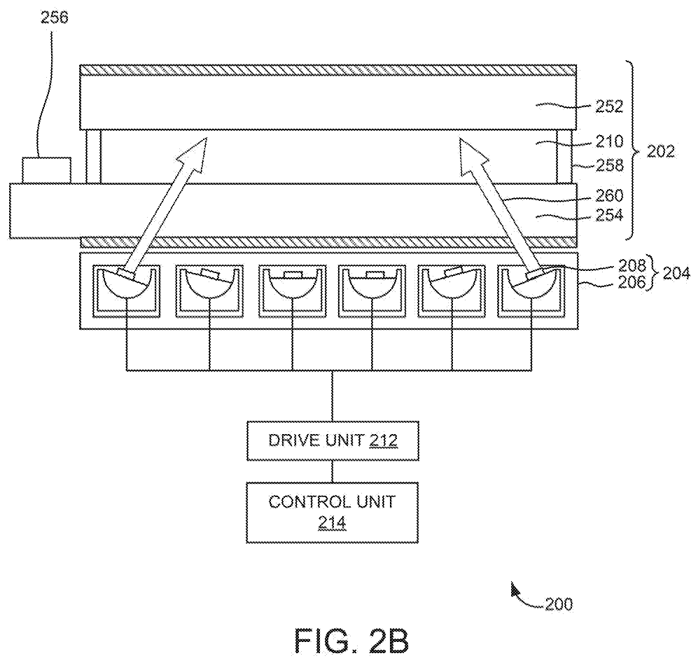

FIG. 2A is a cross-sectional view of an example display device 200, depicting a control unit 214 to rotate an LED 208 to control a viewing angle. Example display device 200 may include a mobile communication device, such as a smart phone, a laptop, a tablet, a convertible device that can be used in both laptop and tablet modes, a media playing device, a portable gaming system, and/or any other type of portable computer device with a display screen that displays visual data. Example display device 200 may include a liquid crystal display (LCD), light emitting diode (LED) display, μ-LED display, mini-LED display, MEMS display, or other displays that includes arrays of LED packages (e.g., LEDs). A μ-LED or mini-LED may be considered as a type of LED. Display device 200 may be equipped with other components such as a camera, audio/video devices, and the like, depending on the functions of display device 200.

Display device 200 may include a liquid crystal panel 202 including a liquid crystal layer 210. Further, display device 200 may include a direct type backlight unit 204. In one example, direct type backlight unit 204 may include a backplane 206 and LED 208 disposed on backplane 206 to provide light towards liquid crystal panel 202 (i.e., to radiate the back light directly to liquid crystal panel 202). In some examples, backplane 206 may be equipped with arrays of spaced LEDs, each LED 208 may include a red μ-LED, a green μ-LED, a blue μ-LED, or any combination thereof. LED 208 may have a first orientation towards liquid crystal panel 202 to provide a first viewing angle. In one example, LED 208 may be disposed on an LED bar that is arranged vertically on direct type backlight unit 204.

Further, display device 200 may include a driving unit 212 coupled to LED 208. Example driving unit 212 may include at least one electric motor. Furthermore, display device 200 may include control unit 214 coupled to driving unit 212. In some examples, control unit 214 may be implemented as engines or modules comprising any combination of hardware and programming to implement the functionalities described herein. In one example, control unit 214 can be implemented as a part of display device 200, for instance, in case of tablet computers. In another example, control unit 214 can be implemented as a part of a base housing (e.g., that houses battery, touchpad, keyboard and the like) of display device 200 and communicatively connected to a display housing of display device 200, for instance, in case of notebook computers.

During operation, control unit 214 may rotate LED 208, via driving unit 212 to have a second orientation towards liquid crystal panel 202 to provide a second viewing angle (e.g., as shown by arrow 260 of FIG. 25). The second viewing angle may be narrower than the first viewing angle. In one example, control unit 214 may control LED 208 or the LED bar such that LED 208 or the LED bar is to rotate towards a vertical center viewing portion of liquid crystal panel 202 to provide the second viewing angle.

For example, the light emitted from LED 208 may exit direct type backlight unit 204 and transmit directly through liquid crystal panel 202 at a first angle in the first orientation. Further, the light emitted from LED 208 may exit direct type backlight unit 204 and transmit directly through liquid crystal panel 202 at a second angle in the second orientation. Also, control unit 214 may control a degree of privacy on liquid crystal panel 202 by rotating LED 208 to multiple positions corresponding to multiple privacy modes. In this case, each position may transmit the light directly through liquid crystal panel 202 at a different angle. Each privacy mode may have a viewing angle that is different from the other privacy modes.

FIG. 2B is across-sectional view of example display device 200 of FIG. 2A, depicting additional features. For example, similarly named elements of FIG. 2B may be similar in structure and/or function to elements described with respect to FIG. 2A. As shown in FIG. 2B, liquid crystal panel 202 may include a thin-film transistor (TFT) substrate 254 and a color filter (CF) substrate 252 arranged above TFT substrate 254. In one example, liquid crystal layer 210 may be arranged between TFT substrate 254 and CF substrate 252.

Also, display device 200 may include a ring of adhesive sealant 258 may surround liquid crystal layer 210. In one example, adhesive sealant 258 may retain liquid crystal material between CF substrate 252 and TFT substrate 254. Also, in the example shown in FIG. 2B, an integrated circuit 256 may be mounted to TFT substrate 254.

Display device 200 may also include other components associated with TFT substrate 254, CF substrate 252, and liquid crystal layer 210. For example, CF substrate 252 may include a black matrix, a color filter alternating red, green, and blue (RGB) with the black matrix therebetween, and a common electrode formed on the black matrix and the color filter. The common electrode is made of transparent conductive material like ITO (indium Tin Oxide) or IZO (Indium Zinc Oxide). Further, display device 200 may include the common electrode and a pixel electrode formed at the inner surfaces facing CF substrate 252 and TFT substrate 254 respectively in order to apply an electric field to liquid crystal layer 210. The liquid crystal panel 202 may also include a polarizer disposed on a rear of TFT substrate 254 and a front of CF substrate 252 for polarizing light transmitted from liquid crystal panel 202.

Even though FIGS. 1 and 2 describe LED packages that are being arranged on the direct type backlight unit in vertical columns, LED packages can also be arranged in horizontal rows or a combination of rows and columns. For example, examples described herein may provide a 2-way or a 4-way privacy control (i.e., a horizontal viewing, angle control and/or a vertical viewing angle control) based on an arrangement of the LED packages on the direct type backlight unit.

Control units 110 and 214 may include, for example, hardware devices including electronic circuitry for implementing the functionalities described herein. In addition or as an alternative, control units 110 and 214 may be implemented as a series of instructions encoded on a machine-readable storage medium of device (e.g., display device 100 or 200) and executable by processor. In examples described herein, the processor may include, for example, one processor or multiple processors included in a single device or distributed across multiple devices. It should be noted that, in some examples, some modules are implemented as hardware devices, while other modules are implemented as executable instructions.

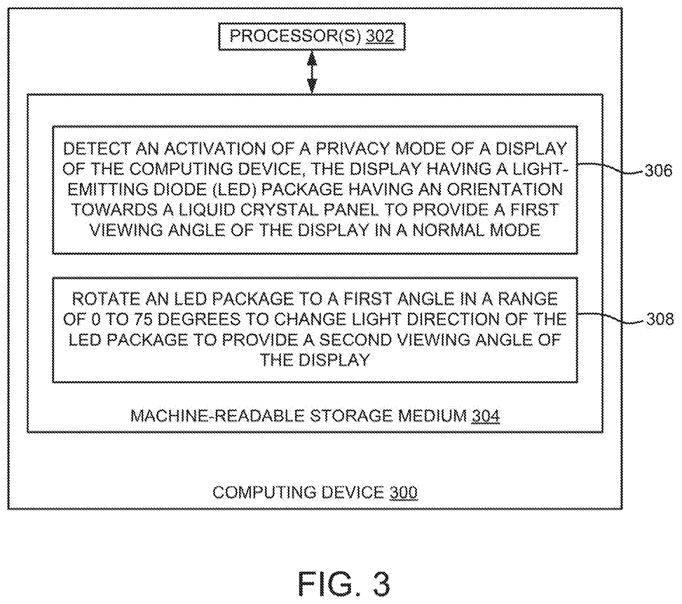

FIG. 3 depicts a block diagram of an example computing device 300 including a machine-readable storage medium 304, storing instructions to implement a privacy mode of a display. Computing device 300 may include a processor 302 and a machine-readable storage medium 304 communicatively coupled through a system bus. Processor 302 may be any type of central processing unit (CPU), microprocessor, or processing logic that interprets and executes machine-readable instructions stored in machine-readable storage medium 304. Machine-readable storage medium 304 may be a random-access memory (RAM) or another type of dynamic storage device that may store information and machine-readable instructions that may be executed by processor 302. For example, machine-readable storage medium 304 may be synchronous DRAM (SDRAM), double data rate (DDR), rarnbus DRAM (RDRAM), rambus RAM, etc., or storage memory media such as a floppy disk, a hard disk, a CD-ROM, a DVD, a pen drive, and the like. In an example, machine-readable storage medium 304 may be a non-transitory machine-readable medium. In an example, machine-readable storage medium 304 may be remote but accessible to computing device 300.

Machine-readable storage medium 304 may store instructions 306 and 308. In an example, instructions 306 and 308 may be executed by processor 302 to control a viewing angle of the display when the privacy mode is activated or deactivated. Instructions 306 may be executed by processor 302 to detect an activation of a privacy mode of a display of the computing device. The display may include an LED package having an orientation towards a liquid crystal panel to provide a first viewing angle of the display in a normal mode.

Instructions 308 may be executed by processor 302 to rotate the LED package to a first angle in a range of 0 to 75 degrees to change light direction of the LED package to provide a second viewing angle of the display, in response to detecting the activation of the privacy mode. The second viewing angle may be narrower than the first viewing angle.

In one example, the LED package may include an LED. The LED may be at the orientation towards and parallel to the liquid crystal panel to provide the first viewing angle. Further, the LED may be rotated to the first angle towards a vertical center viewing portion of the liquid crystal panel to provide the second viewing angle.

In other examples, machine-readable storage medium 304 may include instructions to receive an input to enable a second privacy mode of the display and rotate the LED package to a second angle in the range of 0 to 75 degrees to change the light direction of the LED package to provide a third viewing angle of the display. The third viewing angle may be narrower than the second viewing angle. In this example, the second angle may be greater than the first angle.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where a least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A display device comprising:
a liquid crystal panel;
a direct type backlight unit comprising a light emitting diode (LED) package disposed behind the liquid crystal panel, the LED package including a plurality of LEDs, wherein the plurality of LEDs is to have a first orientation towards the liquid crystal panel to provide a first viewing angle; and
a control unit to rotate the LED package to allow the plurality of LEDs to have a second orientation towards the liquid crystal panel to provide a second viewing angle, the second viewing angle is narrower than the first viewing angle.

2. The display device of claim 1, wherein the control unit is to rotate the LED package at an angle in a range of 0 to 75 degrees.

3. The display device of claim 1, wherein the LED package comprises an LED bar, wherein the plurality of LEDs is disposed on the LED bar.

4. The display device of claim 3, wherein the LED package comprises a driving unit to drive the LED bar to rotate.

5. The display device of claim 4, wherein the driving unit comprises an electric motor, wherein one end of the LED bar is pivoted to a fixed support and other end of the LED bar is connected to an output shaft of the electric motor.

6. The display device of claim 5, wherein the driving unit comprises an electromagnetic switch to activate the electric motor to rotate the LED bar.

7. A display device comprising:
a liquid crystal panel including a liquid crystal layer,
a direct type backlight unit comprising:
a backplane; and
a light emitting diode (LED) disposed on the backplane to provide light towards the liquid crystal panel, wherein the LED is to have a first orientation towards the liquid crystal panel to provide a first viewing angle;
a driving unit coupled to the LED; and
a control unit to rotate the LED, via the driving unit, to have a second orientation towards the liquid crystal panel to provide a second viewing angle, the second viewing angle is narrower than the first viewing angle.

8. The display device of claim 7, wherein the LED is disposed on an LED bar that is arranged vertically on the direct type backlight unit, and wherein the LED comprises a micro LED or a mini LED.

9. The display device of claim 8, wherein the control unit is to control the LED bar such that the LED bar is to rotate towards a vertical center viewing portion of the liquid crystal panel to provide the second viewing angle.

10. The display device of claim 7, wherein the light emitted from the LED is to exit the direct type backlight unit and transmit through the liquid crystal panel at a first angle in the first orientation, and wherein the light emitted from the LED is to exit the direct type backlight unit and transmit through the liquid crystal panel at a second angle in the second orientation.

11. The display device of claim 7, wherein the control unit is to control a degree of privacy on the liquid crystal panel by rotating the LED to multiple positions corresponding to multiple privacy modes, wherein each position is to transmit the light directly through the liquid crystal panel at a different angle, and wherein each privacy mode is having a viewing angle that is different from other privacy modes.

12. The display device of claim 7, wherein the liquid crystal panel comprises:
a thin-film transistor (TFT) substrate; and
a color filter (CF) substrate arranged above the TFT substrate, wherein the liquid crystal layer is arranged between the TFT substrate and the CF substrate.

13. A non-transitory computer-readable storage medium comprising instructions that, when executed by a processor of a computing device, cause the processor to:
detect an activation of a privacy mode of a display of the computing device, the display comprising a light emitting diode (LED) package having an orientation towards a liquid crystal panel to provide a first viewing angle of the display in a normal mode; and
in response to detecting the activation of the privacy mode, rotate the LED package to a first angle in a range of 0 to 75 degrees to change light direction of the LED package to provide a second viewing angle of the display, wherein the second viewing angle is narrower than the first viewing angle.

14. The non-transitory computer-readable storage medium of claim 13, further comprising instructions to:
receive an input to enable a second privacy mode of the display; and
rotate the LED package to a second angle in the range of 0 to 75 degrees to change the light direction of the LED package to provide a third viewing angle of the display, wherein the third viewing angle is narrower than the second viewing angle.

15. The non-transitory computer-readable storage medium of claim 13, wherein the LED package comprises an LED, wherein the LED is at the orientation towards and parallel to the liquid crystal panel to provide the first viewing angle, and wherein the LED is rotated to the first angle towards a vertical center viewing portion of the liquid crystal panel to provide the second viewing angle.
